(19) United States
(12) Patent Application Publication
(10) Pub. No.: US 2008/0122424 A1
(43) Pub. Date: May 29, 2008

(54) Integrated Sensor System Monitoring and Characterizing Lightning Events

(76) Inventors: Yongming Zhang, San Diego, CA (US); Andrew D. Hibbs, La Jolla, CA (US); Robert Matthews, San Diego, CA (US); David Matthew Jabson, San Diego, CA (US)

Correspondence Address: DIEDERIKS & WHITELAW, PLC, 12471 DILLINGHAM SQUARE, #301, WOODBRIDGE, VA, 22192, US

(21) Appl. No.: 11/795,758

(22) PCT Filed: Jan. 24, 2006
(86) PCT No.: PCT/US06/02376

§ 371 Date: Jul. 20, 2007

Related U.S. Application Data
(60) Provisional application No. 60/645,729, filed on Jan. 24, 2005.

(51) Int. Cl. G01W 1/00

(52) U.S. Cl. 324/72

(57) ABSTRACT

A compact sensor system integrates electric and magnetic field sensors to accurately measure, with a high level of sensitivity, electric and magnetic fields. The sensor system is self-contained so as to include a built-in power source, as well as data storage and/or transmission capability. The integrated sensor system also preferably includes a global positioning system (GPS) to provide timing and position information, a sensor unit that can determine the orientation and tilt of the sensor system, and self-calibrating structure which produces local electric and/or magnetic fields used to calibrate the sensor system following deployment. The system measures the electromagnetic signals produced by lightning and more has the capability to determine the direction and distance to a lightning event without input from sensors at other locations. Furthermore, the system can detect both conventional short-duration lightning events and also the less common, but more destructive, continuing current lightning.

### CROSS-REFERENCE TO RELATED APPLICATION

The present application is a continuation-in-part of U.S. application Ser. No. 10/959,480 entitled “Integrated Sensor System for measuring electrical and/or magnetic field vector components” filed on Oct. 7, 2004 which claims the benefit of U.S. Provisional Patent Application Ser. No. 60/509,423 entitled “Integrated Electric and Magnetic Field Sensor” filed Oct. 7, 2003 and also claims the benefit of U.S. Provisional Patent Application Ser. No. 60/645,729 entitled “Integrated EM Sensor for Lightning Monitoring and Characterization” filed Jan. 24, 2005.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of DARPA

### BACKGROUND OF THE INVENTION

1. Field of the Invention

The present invention pertains to systems for measuring electromagnetic fields and, more particularly, to a compact, integrated electromagnetic sensor system that has the capability to determine the direction and distance to a lightning event without input from sensors at other locations.

2. Discussion of the Prior Art

Measurements of electric and magnetic fields at low frequencies, generally less than 1 kHz, have been made for many years using discrete sensors to measure the electric field (E-field) and magnetic field (B-field) separately. In addition, it has been proposed to integrate electric and magnetic components into a single sensor. However, when a high level of sensitivity is required, individual sensors are invariably utilized to measure desired components of each field. For example, to make a magnetotelluric measurement, individual magnetic induction sensors are laid on the ground at a separation of a few meters and rods are buried in the ground nearby to measure the horizontal electric field. In most cases, the respective sensors must all be aligned relative to one another and mounted with sufficient rigidity to minimize relative motion. Depending on the accuracy required, such an installation can take a significant time to complete and requires an area in the order of 10 m² to operate.

Prior high sensitivity induction sensors have been too large to integrate together. While one cylindrical object of length even up to 2 m is relatively easy to handle and transport, a system comprised of two or three such sensors at right angles to each other, if even contemplated, would be very cumbersome. In addition, prior induction sensors designed for detection of small low frequency signals had diameters in the order of 3 cm or more. Simply stated, prior induction sensors and arrangements that involve them are quite large and sub-optimal, while being inefficient to set-up and operate.

In many applications, the ability to reasonably employ a dual field sensor system will depend on the compactness and even weight of the system. These applications include the installation of dual field sensors in aircraft, spacecraft and ground vehicles, as well as situations where the sensor system must be deployed in a certain way such as hand or air-drop deployment situations. The time consuming set-up and lack of compactness in prior proposals has essentially limited the use of collected E-field and B-field information to geophysical applications, such as magnetotellurics and the measurement of lightning, wherein the sensors can be positioned over a relatively wide area.

When electric and magnetic field data has been collected together, the objective has generally been to collect an individual field parameter as a record of a specific physical phenomena, e.g. lightning. However, the present Applicants have recognized that specific vector components of known orientation in the electric and magnetic field data can be combined to produce a reduced output. For instance, new combined electric and magnetic measurement applications arise, including using information in one measurement channel, e.g., an electric field vector component, to reduce environmental noise in other channels, e.g., multiple magnetic field vector components. In addition, the ratio of various signals in different electric and magnetic axes can be determined to provide source characteristic capabilities.

Lightning is a transient electrical discharge within the atmosphere that is typically either intracloud (IC) or from cloud to ground (CG). Lightning can be detected by the pulse of electromagnetic energy associated with it. This pulse produces signals over a wide frequency range that can be measured by a variety of receivers.

There are a multitude of detectors that have been described for detecting and providing warnings about lightning, some of which provide range information but not direction. In U.S. Pat. No. 4,801,942, Markson et al. describes an interferometric lightning ranging system that determines the range between an object in flight that carries the detection system and the lightning stroke. This technique uses the travel-time difference between the signal that travels directly to the system and a signal that bounces off the ground before being detected. This technique cannot be applied to systems on the ground.

In U.S. Pat. No. 6,828,911, Jones et al. describes a system that can detect lightning strikes within at least one-half mile by looking at the modulation to an electrostatic sensor that is kept at a reference voltage. In U.S. Pat. Nos. 5,263,368 and 5,541,501, handheld lightning ranging and warning devices are described which use bandpass filters to analyze the frequency spectrum of radiation emitted by the lightning. Different frequency regimes are attenuated at different rates with respect to distance, allowing the relative magnitudes at different frequencies to be used to determine the distance to the stroke.

To locate the position of a lightning event, the times of arrival of the signal at three or more discrete antennae separated by hundreds of kilometers can be recorded and the distance of the lightning from each sensor location is then deduced via the speed of light. This method, called triangulation, forms the basis of many patents related to lightning detection and location, including U.S. Pat. Nos. 4,543,580, 4,792,806, 4,115,732 and 4,245,190. This method is effective and forms the basis of the National Lightning Detection Network (NLDN). It requires a large installed array of recording stations with accurate timing and the capability to relay the signals detected to a central monitoring and processing facility via satellites. To access the data in real time, the user must have a communication link to the central facility.

It is not always convenient to maintain a long distance data link and further, in most parts of the world, a large installed array, such as the NLDN, does not exist. For these reasons, it is desirable to locate the positions of lightning strikes by measurements at a single location only. In U.S. Pat. No. 6,246,367, Markson et al. describes a system for detecting the initial leader stroke and, in one embodiment, the system includes a sensor at one location only. In this embodiment, the electric field amplitude provides the distance to the stroke, while crossed loop antennae determine the direction. Medelius et al., in U.S. Pat. No. 6,552,521 describes a single-station system for locating lightning strikes that uses the difference in travel time between the electromagnetic pulse and the thunder acoustic pulse to provide the range, while the azimuth is determined by a co-located array of acoustic sensors. In NOAA Technical Report ERL 195-APCL 16, Runke describes a method of determining the location of lightning using two loop antennae to measure the magnetic field and one wire antenna to measure the electric field. The ratio of the magnitude of the magnetic field to the electric field is a function of distance and hence can be used to determine how far the detector is from the lightning.

Regardless of the known prior art arrangements, there still exists a need to combine one or more electric field sensors with one or more magnetic field sensors to establish an integrated sensor system which is compact in nature in order to employ the sensor system in a wide range of applications. In addition, there exists a benefit to be able to readily combine different data from individual axes of such an integrated sensor system in order to take advantage of particular relationships between the electric and magnetic fields that pertain to certain properties of the environment or source(s) of interest. Particularly, there exists a need to provide such a system that can monitor, and preferably characterize, lightning without input from an external, larger system and is small enough to be carried in a vehicle or even by a human being.

### SUMMARY OF THE INVENTION

The present invention is directed to an integrated and compact sensor system for determining electric and/or magnetic vector component information of fields. Sensors are maintained at fixed, well defined relative positions for generating signals from which the vector information is determined. Different data from individual axes of the integrated sensor system is preferably combined in a manner which takes advantage of particular relationships between the electric and magnetic fields.

In accordance with a preferred embodiment of the invention, multiple sensors are employed for measuring the electric and/or magnetic fields, with the multiple sensors being preferably, rigidly connected together along defined, intersecting axes, while communicating with a controller for processing and analyzing the data. In accordance with the most preferred embodiment of the invention, the sensor system is self-contained so as to include a built-in power source, as well as data storage and/or transmission capability, such that the system can operate without an electrically conducting contact with the surrounding environment.

In addition to the electric and/or magnetic field sensors, the integrated sensor system also preferably includes a global positioning system (GPS) to provide timing and position information. Furthermore, a sensor unit which can determine the orientation and tilt of the sensor system can be incorporated as well. Also, the sensor system can be self-calibrating, wherein structure is provided to produce local electric and/or magnetic fields which are used to calibrate the sensor system following deployment.

In accordance with a particular aspect, this invention pertains to a compact integrated system for measurement of the electromagnetic signals produced by lighting. The system has the capability to determine the direction and distance to a lightning strike or event without input from sensors at other locations. Furthermore, the system can detect both conventional short-duration lightning events and also the less common, but more destructive, continuing current lightning. Such a system has use in protecting life and personal property. Its compact nature makes it possible to install the system in small aircraft and boats, or to hand-carry it to an area of interest, such as a forested area that might be prone to fires.

The invention is based on both electric (E) and magnetic (B) field sensors that are integrated into a compact package. The basic form of the system combines one E-field and two B-field sensors arranged in orthogonal directions. To accurately determine the direction from the sensor system to the lightning event, the system is aligned with the E-field detection axis to the vertical and the B-field horizontal in North-South and East-West directions by reference to external instruments, or preferably orientation and tilt sensors are integrated into the sensor to allow the data that is collected to be projected into these cardinal directions. Alternatively, the lightning detection sensor can incorporate 3-axis B-field and/or 3-axis E-field sensors. From the well defined polarization of the electromagnetic signal produced by lightning, the 3-axis sensor outputs are used to determine the components of the B-field in the horizontal plane and the component of the E-field in the vertical direction. The respective sensors are about one hundred times smaller than conventional E and B sensors, allowing a very compact overall unit. Their ultra-high sensitivity makes it possible to detect lightning discharges from very long distances of up to 1000 km. The simultaneous measurement of the electric and magnetic fields allows the direction to the lightning stroke to be determined, while the time between the initial direct signal and signals that have bounced off the ionosphere allow the distance to the stroke to be determined. The entire sensor system is preferably less than 30 cm in any dimension, and, more preferably, less than 20 cm. Preferably the E-field sensor is a solid-state device with no moving parts and mounted onto the end of a B-field sensor.

Additional objects, features and advantages of the present invention will become more readily apparent from the following detailed description of preferred embodiments when taken in conjunction with the drawings wherein like reference numerals refer to corresponding parts in the several views.

### BRIEF DESCRIPTION OF THE DRAWINGS

FIG. 1 is a perspective view of an integrated electric (E) and magnetic (B) field sensor constructed in accordance with a preferred embodiment of the invention;

FIG. 2 is a perspective view of an integrated E and B sensor system constructed in accordance with another embodiment of the invention that measures non-orthogonal components of electric and magnetic fields;

FIG. 3 is a perspective view of an integrated sensor constructed in accordance with a still further embodiment of the invention;

FIG. 4 is a block diagram illustrating control aspects of the invention;

FIG. 5 is a perspective view of an integrated sensor constructed in accordance with a still further embodiment of the invention;

FIG. 6 is a block diagram illustrating the system architecture;

FIG. 7 shows a side perspective view of an integrated electromagnetic sensor including orientation and tilt sensors, GPS position and time determination, and digitization and processing electronics;

FIG. 8 shows a top perspective view of the integrated electromagnetic sensor of FIG. 6 including orientation and tilt sensors, GPS position and time determination, and digitization and processing electronics;

FIG. 9 is a flowchart showing the steps of a method for determining a lightning event in accordance with a preferred embodiment of the invention;

FIG. 10 shows an example of a lightning strike with detectable continuing current measured by E field sensors in accordance with a preferred embodiment of the invention; and

FIG. 11 shows an example of a lightning strike with detectable continuing current measured by B field sensors in accordance with a preferred embodiment of the invention.

### DETAILED DESCRIPTION OF THE PREFERRED EMBODIMENTS

The present invention provides advances in connection with establishing a compact sensor system that can measure multiple vector components of both electric and magnetic fields at very high sensitivity. By a “compact” sensing system it is meant that the region over which a particular field is measured is small relative to the spatial variations in the field that are of interest, and/or is sufficiently compact that a system that measures multiple components of the field is of a convenient size. As will become fully evident below, the compact nature and arrangement of the various sensors allows the sensors to intersect at a common center, while enabling minimum lateral offsets between the sensors.

An example of a multi-axis, combined E-field and B-field sensor system 300 built according to a preferred embodiment of the invention is shown in FIG. 1. In this system, three orthogonal axes of an electric field are measured with various capacitive sensors 330-335 arranged as pairs in orthogonal oriented directions. To measure the electric field, it is only necessary to measure the potential at two points, subtract one result from the other, and divide by the physical distance, d, between the two points, and multiply by a calibration constant k which is close to unity to allow for the design of the sensor, with k being readily determinable by testing the sensor in a known field.

$$E = k \frac{{V}_{1} - {V}_{2}}{d} \qquad [ 1 ]$$

As will be detailed more fully below, the two measurements can be made by completely different sensors or by connecting two separate potential sensors to an appropriate amplifier with a differential input. The voltage of one sensor can be subtracted in a pair-wise fashion from multiple other sensors to provide the electric field in the direction of the vector joining the measurement points according to the above equation. As shown, each of the six sensors 330-335, which preferably take the form of conducting plates, functions to measure an electric potential in the form of a respective voltage V₁-V₆ at its geometric center. More specifically, sensors 330-335 are linked and maintained at fixed relative positions through respective support arms or rods 340-345 to a main body or housing 350 through insulators, such as that indicated at 352 for support arm 340. In accordance with this form of the invention, housing 350 is formed from attaching three individual sensor modules 355-357, with sensors 330 and 331 being carried by module 355; sensors 332 and 333 being carried by module 356; and sensors 334 and 335 being carried by module 357. Support arms 340 and 341 are preferably coaxially aligned along a first axis, while support arms 342 and 343 extend coaxially along a second axis and support arms 344 and 345 extend coaxially along a third axis. As shown, the second axis associated with support arms 342 and 343 is arranged substantially perpendicular to the first and third axes.

Housing 350 also includes first and second end caps, one of which is indicated at 370. Within housing 350 is the electronics (not shown) associated with sensor system 300. Also projecting from each module 355-357 are respective electrical connectors, such as those indicated at 380-382 for module 355. Electrical connectors 380-382 are provided to link each module 355-357 of housing 350 to electrical components employed in reading and evaluating the signals received from sensor system 300. In addition, each module 355-357 includes an associated power switch, such as power switches 385 and 386 for modules 355 and 356 respectively. At this point, it should be understood that housing 350 could be integrally constructed, while employing only one set of electrical connectors 380-382 and one power switch 385, 386.

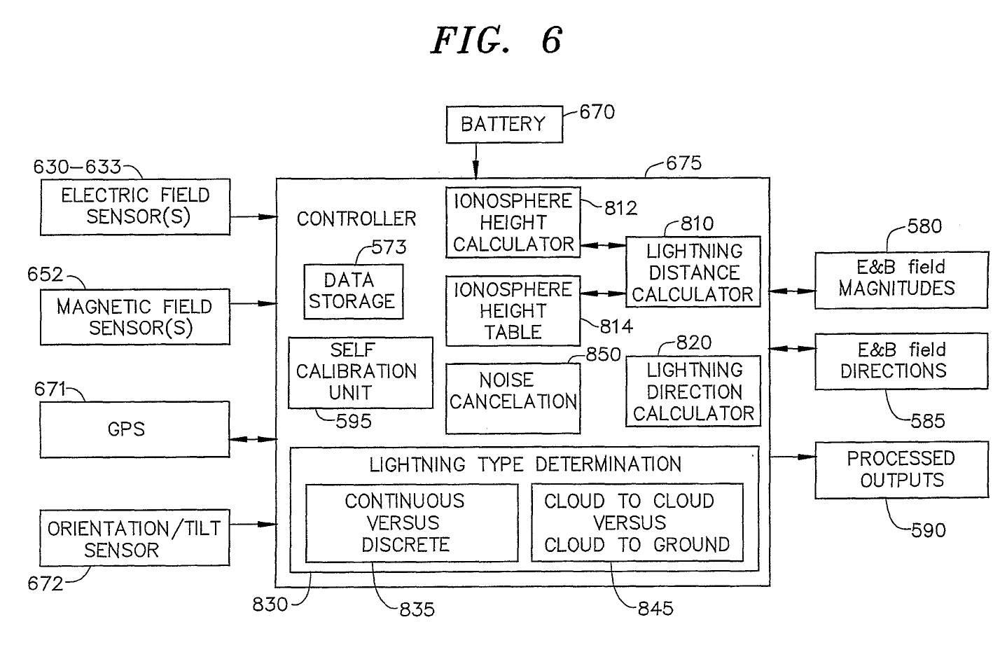

With this arrangement, electric fields are constructed in the following manner: E_{X}=kₓ(V₁−V₂+V₅−V₆)/2, E_{Y}=k_{Y}(V₃−V₄), E_{Z}=k_{Z}(V₁+V₂−V₅−V₆)/2 in which the plate voltages Vᵢ and the constants kᵢ are determined by calibration in a known electric field prior to actual use of sensor system 300. By virtue of the design of the capacitive-type, multi-component electric field sensor system 300 represented in FIG. 6, the three measured field components Ex, Ey and Ez intersect centrally in modules 355-357 of housing 350. However, it should be noted that the individual sensing arrays established by sensors 330-335 need not be arranged perpendicular with respect to each other, but rather only sufficient projection in orthogonal directions is needed to estimate the fields in those orthogonal directions.

As indicated above, electric field sensors 330-335 are spaced by arms 340-345 and insulators 352. In accordance with a preferred embodiment of the invention, each insulator 352 actually defines a magnetic field sensor, preferably an induction-type magnetic field sensor. Therefore, sensor system 300 preferably includes a corresponding number of magnetic field sensors 352 as electric field sensors 330-335. Positioning magnetic field sensors 352 in the manner set forth above enables magnetic field sensors 352 to perform a dual function of insulating the electric field sensors 330-335 and sensing various vector components of a given magnetic field. Although separate insulators and magnetic field sensors could be employed, this arrangement contributes to the compact nature of sensor system 300, while also minimizing costs. In any case, sensor system 300 can advantageously sense both electric and magnetic fields and, more specifically, vector components of each of electric and magnetic fields. Integrating the E and B sensor hardware obviously results in a smaller, lighter and less expensive system. These are significant benefits in their own right and make possible some applications, such as deployment of sensor system 300 on an aircraft.

At this point, it should be noted that support arms 340-345 could actually define the magnetic field sensors, while also spacing and insulating the various electric field (potential) sensors 330-335. In this case, the outer casing (not separately labeled) of each support arm 340-345 acts as the insulator. Instead, a separate insulator could be employed to carry a respective electric field sensor 330-335. In any case, the magnetic field sensors are shown as structural extensions between housing 350 and electric field sensors 330-335 which adds to the compact nature of the overall sensor system.

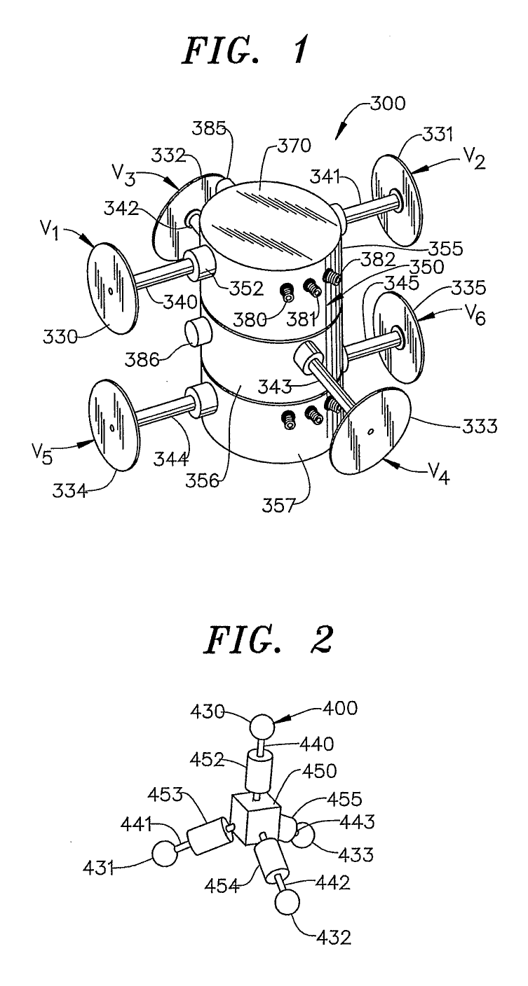

FIG. 2 shows an integrated electric and magnetic field sensor system 400 constructed in accordance with another embodiment of the invention. Sensor system 400 is basically presented to illustrate that the field measurements need not be made along purely orthogonal axes.

Instead, if desired, the field components in orthogonal directions can be calculated via simple geometry by methods well known in the art. To this end, note that sensor system 400 includes sensors 430-433, a housing 450, support arms 440-443 and magnetic sensors/insulators 452-455. With this arrangement, various components of both electric and magnetic fields can be sensed by sensors 430-432 and 452-455 respectively, with the signals therefrom being processed to establish orthogonal field measurements through simply knowing the geometrical relationship between the respective sensors 430-433, 452-455. Therefore, sensor system 400 can operate in a manner corresponding to sensor system 300, with fewer support arms and sensors, while requiring some mathematical manipulation of the signals to arrive at corresponding processed field data.

FIG. 3 presents the most preferred embodiment of the invention wherein a sensor system 500 includes a plurality of electric field sensors 530-534 which are supported from a generally puck-shaped housing 550 through respective support arms 540-544. Each support arm 540-544 also has associated therewith a respective magnetic sensor, one of which is indicated at 552 for support arm 540, that also functions as an insulator. The electric potential sensor is now self-contained in the sense that the first stage high input impedance electronics that was formerly located in housing 350 is now located with housing 530. The difference in the outputs of these sensors can be combined as in Equation 1 set forth above, to produce the value of the E-field between them.

Sensor system 500 shows a total of five electric potential sensors 530-534. In this embodiment, the field along the vertical axis of the sensor is calculated by subtracting the output of sensor 530 from the average of the outputs of sensors 531-534. If desired, a sixth sensor (not shown) can be positioned at the bottom end of the magnetic sensor 552 to provide a single measurement point for the second potential measurement along the vertical axis. The advantage of the five sensor embodiment 500 shown in FIG. 3 is that, by not having a sensor in the lower part of the system, a mounting means can be positioned there instead.

As with the other embodiments disclosed, sensor system 500 is preferably battery powered. The signals recorded by each sensor 530-534, 552 is made relative to the battery voltage that powers sensor system 500. When the common points of the batteries of any two sensors are connected together, the difference of the sensor outputs gives a reading directly proportional to the particular field. In a preferred version of the multi-axis, multi-field system, a DC battery unit 570 is used for sensors 530-534 and 552, thereby ensuring that all measurements are relative to a common reference. In any case, using the approach of FIG. 3 advantageously enables electric field sensors 530-534 and magnetic sensors 552 to be situated at any desired position.

The most preferred magnetic field sensor to use in the invention is a magnetic induction sensor that incorporates a high permeability material (the core) in order to concentrate magnetic flux. When suitably designed, such a sensor has the highest sensitivity of all types of room temperature magnetic field sensors. For example, a sensitivity of 0.2 pT/Hz^{1/2} at 10 Hz and 0.03 pT/Hz^{1/2} at 100 Hz can be achieved using a device less than 50 cm in length and 2 cm in diameter. To integrate two more such sensors together so that they intersect at their midpoints with minimal lateral offset (less than 1 cm), it is important to design the sensor with the minimum outer diameter and also to split the sensor winding so that the sensor midpoint has a cross-section only a little larger than the high permeability core material. By minimizing the lateral offset, the orthogonality between sensor outputs is maximized. A compact integrated magnetic induction sensor system so designed is an ideal sensor unit for use with electric field sensors in the manner shown in FIG. 3 and, in addition, can be used as a multi-axis highly sensitive magnetic field sensor in its own right.

FIG. 3 also illustrates other potential features of the sensor system of the present invention. More specifically, the sensor system 300, 400, 500 of the invention could also incorporate a global positioning system (GPS) 571 including a receiver and/or transmitter (not separately labeled) for use in connection with timing and position information. In addition, a sensing unit 572 can be provided to determine the actual orientation and tilt of sensor system 300, 400, 500. Such a sensing unit 572 is known in other arts so will not be described further here. By way of example, sensing unit 572 is employed in determining the tilt angle α of a predetermined axis of sensor system 300, 400, 500 relative to a plane substantially parallel to the earth's surface when the invention is utilized in a geophysical environment. Sensor system 300, 400, 500 also preferably includes a data storage pack 573 for storing electric and magnetic field data that can be transmitted through either wired or wireless connections.

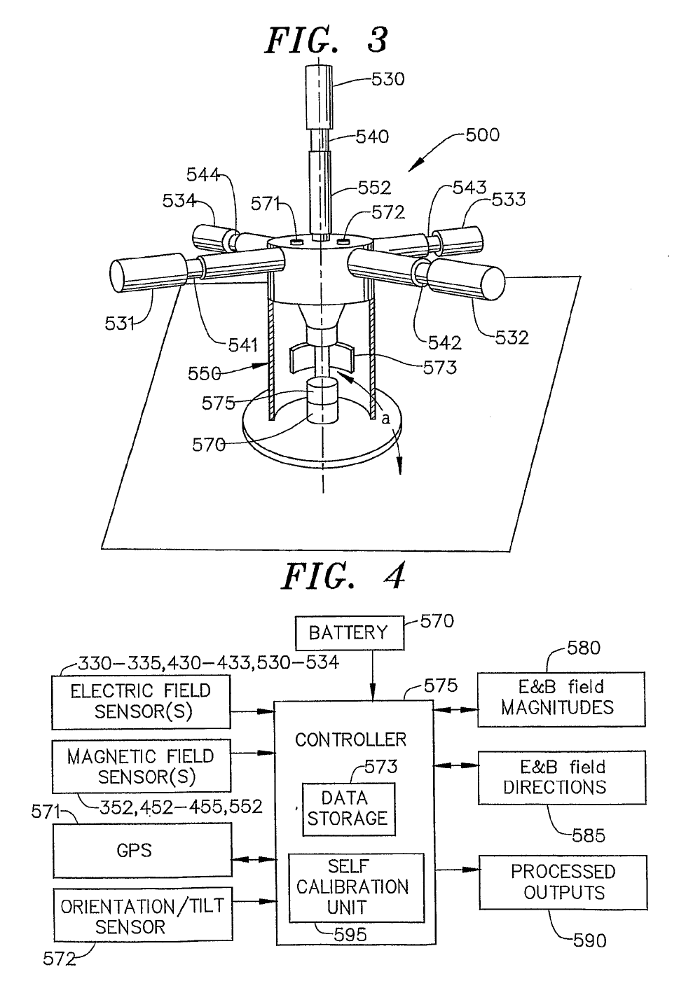

As the particular circuitry employed in connection with the sensor system is not part of the present invention, it will not be described in detail here. However, FIG. 4 generally illustrates basic aspects of the present invention wherein both electric and magnetic field data is sent to a controller 575 in order that the signals can be processed to determine one or more vector components of the electric and/or magnetic field as represented by magnitude data 580 and direction data 585. On a general note, a high-impedance amplifier is preferably connected to each sensor. The amplifier is configured to buffer the output of the sensor and send a representative signal to a subsequent low-impedance circuit. In any case, each sensor is preferably modulated in time in order to increase its sensitivity.

In many cases, a considerable benefit of using both E and B sensors is not just to collect their individual outputs separately, but rather to combine their outputs to provide an integrated, processed electromagnetic system output. The capability to provide an integrated multi-axis electric field measurement is itself advantageous, and the further integration of electric field measurement with one or more axes of magnetic field measurement as set forth in accordance with the present invention provides additional measurement schemes which result in specific electromagnetic sensing opportunities. As will be detailed more fully below, the electric and magnetic field data can be synthesized to reduce the amount of output by combining channel data, while yielding improved fidelity by exploiting specific physical relationships between E and B data for specific targets and environmental conditions.

It is generally desired to combine the particular components of the E and B fields measured relative to the terrestrial frame of reference. Specifically, it is important to determine the vertical component (E_{z}, B_{z}) and/or the horizontal components, (Eₕ, Bₕ) of each field in order to accurately determine the direction from the sensor system to the lightning strike. Such a measurement can be arranged by aligning the sensor system along the axis of maximum gravitational field such that the desired sensor axis is situated in a desired orientation, or by mathematically rotating the output of multiple sensor channels to synthesize a desired measurement, using information from either a separate sensor or an internal calibration arrangement to determine the orientation of the sensor system.

A general case is to compute the correlation between different pairs of E and B sensor data. This approach relies upon the fact that the predominant cause of E-field noise is the motion of airborne charged dust and particulates, while the predominant cause of B-field noise is the motion of the sensor itself due to seismic induced vibration or wind buffeting. These noise sources are not generally correlated in a time domain, and so they will not appear in a correlated output. This method is particularly effective when looking at electromagnetic transients (pulses in E and B) that are produced by some sources. The general expression for the correlation of two continuous time domain signals g and h is given by:

$$Corr ( g , h ) ≡ {\int }_{- ∞}^{∞} g ( τ + t ) h ( τ ) d t$$

The parameter t is a lag applied to one of the signals, generally used as a method to determine at what offset the two signals are most common (i.e. have the highest correlation). For the application of noise rejection in two simultaneous signals the value of t will be 0 so the equation simply becomes

$$Corr ( g , h ) ≡ {\int }_{- ∞}^{∞} g ( τ ) h ( τ ) d τ$$

### The discrete form of the equation is then given by

$$Corr ( g , h ) ≡ {\sum }_{k = 0}^{N} {g}_{k} {h}_{k}$$

where N is the interval over which the correlation is considered. To account for varying values of N and differences in signal amplitudes, the correlation is often normalized as such:

$$Corr ( g , h ) ≡ \frac{{\sum }_{k = 0}^{N} {g}_{k} {h}_{k}}{\frac{1}{N + 1} \sqrt{{\sum }_{k = 0}^{N} {g}_{k}^{2} {\sum }_{k = 0}^{N} {h}_{k}^{2}}} \qquad 1$$

Another integrated electric and magnetic measurement according to the invention is to compute the coherence between the horizontal components of E (Eₓ, E_{y}) and B (Bₓ, B_{y}). The advantage of this method is that it is generally easier to position sensors in the horizontal plane by taking advantage of the ground surface or by the aspect ratio of a wing structure for an airborne platform. A vertical sensor is susceptible to increased wind induced noise in dependence upon the extent the sensor projects above the ground and, at least in many cases, burying the sensor is not practical. The benefit of taking the coherence between horizontal channels is that, at the high sensitivity provided by the invention, horizontal B-field sensors are limited at low frequency by geoatmospheric (GA) noise. However, there is no GA noise in horizontal E-field sensors and so the noise is not coherent. This method provides an increased signal to noise ratio (SNR) in cases when the signal of interest is present in both Eₕ and Bₕ. Coherence is expressed as

$$γ = \frac{\vert {S}_{XY} \vert}{\sqrt{{S}_{XX} {S}_{YY}}}$$

### Where S_{XY} is the cross spectral density between the two signals x[t] and y[t] and S_{XX} and S_{YY} are the autospectra, while X(f) and Y(f) are the Fourier transforms of the two measured variable x[t], y[t], and Y′(f) is the complex conjugate of Y(f).:

$$γ = \frac{\vert X ( f ) {Y}^{′} ( f ) \vert}{\sqrt{{\vert X ( f ) \vert}^{2} {\vert Y ( f ) \vert}^{2}}} \qquad$$

A further integrated electric and magnetic measurement according to the invention is to input the data from both components of horizontal B (Bₓ, B_{y}) and vertical E (E_{z}) in a coherent canceling algorithm. The method relies on the fact that Bₕ and E_{z} both contain coherent GA noise, which is then cancelled. The method is suitable for sources that, due to their configuration, produce horizontal B but minimal E_{z}, or vice versa. A suitable such canceling algorithm is a Wiener filter which provides the set of optimum coefficients to subtract an estimation of the noise alone, xₖ, from a noise-contaminated signal yₖ:

$${W}_{OPT} = \frac{E [ {y}_{k} {X}_{k} ]}{E [ {X}_{k} {X}_{k}^{T} ]} \qquad 2$$

Where E[ ] symbolizes the expected value. E[yₖXₖ] is the N length cross-correlation vector and E[XₖXₖ^{T}] is the N×N autocorrelation matrix (N being the number of filter coefficients). The output signal of the filter is then:

$${e}_{k} = {y}_{k} - {\sum }_{i = 0}^{N - 1} w ( i ) {x}_{k - i}$$

This is the optimal filter and can be made adaptive by continuously updating the correlation vectors. Various types of Least Mean Square algorithms can be used to modify the set of filter coefficients on a sample-by-sample basis to achieve an estimation of the optimum set that adapts to changing noise characteristics.

A still further electric and magnetic integrated measurement algorithm is, in a sense, the inverse of the just prior method and applies to situations in which a vertical sensor direction is made easy by an implanted stake or preexisting vertical structure. The core idea is to calculate the coherence between vertical B and horizontal E. Vertical B is generally limited by vibration-induced noise owing to the way and upright sensors couple to seismic ground motion, as well as the increased wind force in the event that the sensor protrudes above the ground. Eₕ has negligible vibration induced noise and so an algorithm that produces the coherence between B_{z} and Eₕ will have negligible vibration signals and so reduced noise.

The above-described control arrangements are particularly suited to primarily magnetic sources because such sources also generate horizontal and vertical electric fields via the electric currents they induce in the ground. Such sources can be either above ground or below ground. In some cases it is important to distinguish between a signal produced in the ground and a man-made signal produced remotely and traveling through the air. An example of this is to remove interference from above ground power lines from a measurement to locate a buried power cable.

A still further control arrangement according to the invention is to input a measurement of E_{z} into a coherent canceling algorithm to remove above ground power line interference from horizontal E-field and/or B-field data. This method relies on the fact that the electric field produced by an above ground source is predominantly only in the vertical direction due to the conductivity of the earth. Based on the above description, it should be appreciated that, in a multi-axis integrated electric and magnetic sensor system as described by the invention, one or more of the measurement arrangements described above can be employed simultaneously in parallel. In addition, the noise reduced data produced by one arrangement can be used as inputs to other control functions to provide further improvements.

As indicated above, the detected electric and magnetic field data can be separately stored and/or outputted, or further processed by controller 575, such as combining the various data in the ways discussed above, in order to establish processed data outputs as represented in FIG. 4 at 590. In many practical situations, it is very desirable to be able to confirm that a sensor is operating at its intended performance level and has not been damaged or otherwise become compromised. Furthermore both electric and magnetic field sensors can be strongly affected by being placed in close proximity to natural objects. For example, if an E-field sensor is close to a large conducting object, the field in its local vicinity will be distorted. Another scenario is a change in the coupling efficiency at the sensor input. If the sensor is placed on uneven ground so that one E-field detection surface is much closer to the ground than the others, the effective capacitance of this sensor will be altered and the fraction of the free space field coupled into the sensor changed. Another such scenario concerns the presence of a film of water on the sensor might act to provide an impedance to ground at its input or a shorting impedance between two sensors. In the case of a B-field sensor such effects could occur if the sensor is located in close proximity to a highly permeable object, such as an iron plate in the ground, or very high permeability soil.

A preferred method to monitor these effects is to provide a means on the sensor to create local electric and/or magnetic fields (represented by self-calibrating unit 595 in FIG. 4). An electric field can be produced by a small conducting surface driven at a desired potential, and a magnetic field produced by a small coil wrapped about the body of the sensor and carrying a desired current. These surfaces and coils are made small enough so as to be integrated into the body of the sensor, and not be externally visible. In both cases, the frequency of the potential or current can be swept over a desired range to provide a measure of the frequency response of the sensor of interest. The conducting surfaces and coils are connected rigidly to the sensor so that their positions and couplings will not change under normal operating conditions.

The system calibration is established before use under controlled conditions. Once the sensor is placed in a desired position, the calibration routine can be run as desired to confirm that the sensor is still operational in that it measures the known generated fields. If an improper or no response is detected, it is immediately obvious. Moreover if a small frequency dependent deviation is observed from the expected response, then this deviation can be use to provide diagnostic information as to the source of the problem. In some case the measured data can be corrected by the modified response function to give a more accurate record of the field measured by the sensor.

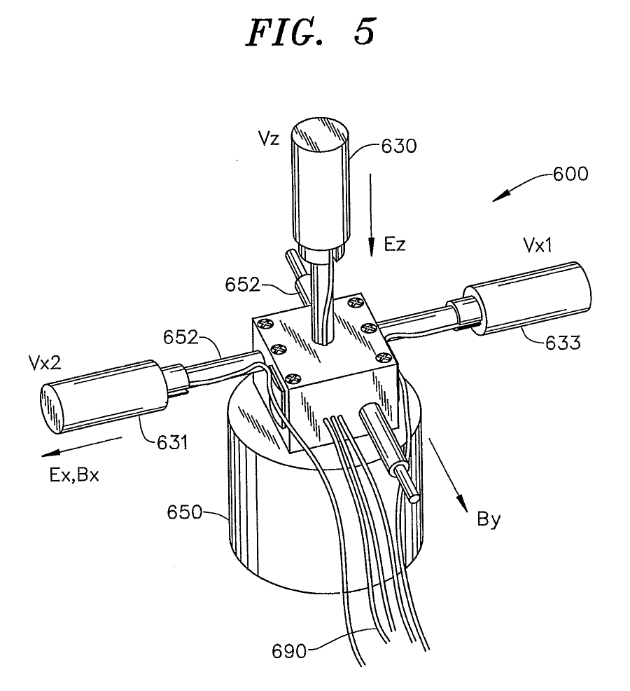

In yet another embodiment of the invention as shown in FIGS. 5 and 6, a sensor system 600 is contained in a weatherproof housing 650. Sensor system 600 has its own DC power source or battery 670 and incorporates various sensors 630-633 and 652. At a minimum, sensor system 600 includes at least two highly sensitive orthogonal magnetic induction (B-field) sensors 652 and at least one highly sensitive electric field (E-field) sensor 630. Additionally, sensor system 600 contains a GPS 671 and orientation/tilt sensors 672 for determining the precise location and orientation of system 600. System 600 also contains embedded controller(s) 675 that process the signals measured by the E-field and B-field sensors 630-633, 652. In the particular case of a lightning event, controller 675 will actually determine the physical properties of the lightning discharge. In addition these measurements allow controller 675 to determine whether the lightning event was continuing current lightning, and also whether it was cloud-to-ground or intracloud lightning.

FIG. 6 shows the same general aspects of the invention as shown in FIG. 4 and discussed above with the addition of several components used to calculate various aspects of a lightning event. More specifically, controller 675 includes a lighting distance calculator 810 that uses inputs from an ionosphere height calculator 812 or an ionospheric height lookup table 814. A lightning direction calculator 820 determines the direction of a lightning event. A unit 830 determines the type of lightning. Part 835 of unit 830 will determine if the lightning event is continuous or discrete, while part 845 will determine if the lightning is traveling from cloud to cloud or cloud to ground. A circuit 850 is also provided for noise cancellation.

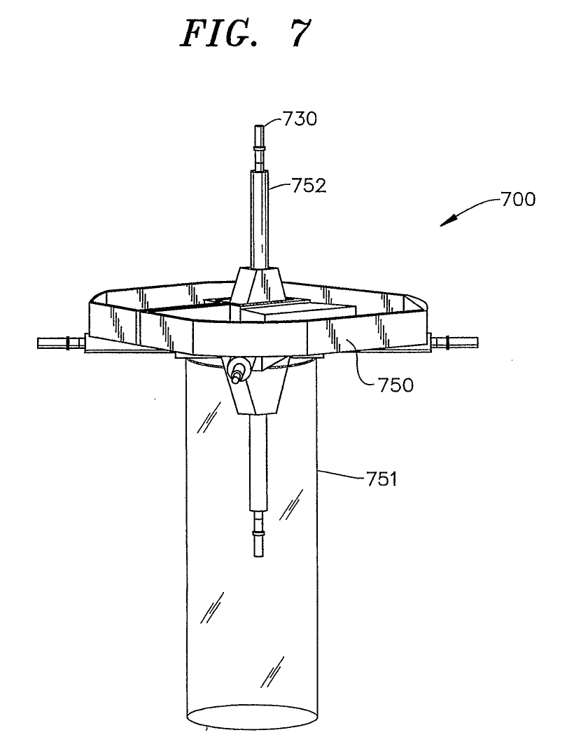

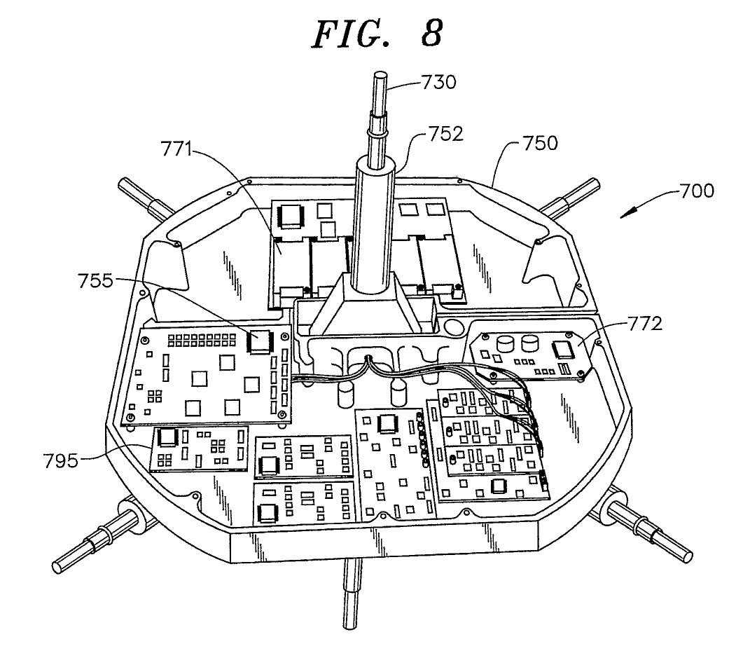

FIGS. 7 and 8 generally illustrate the basic aspects of a further embodiment of the invention including a sensor system 700. A housing 750 of system 700 is shown with no top, but positioned on a cylindrical base 751. A controller or central processor 755 is mounted so as to receive information from a GPS 771, orientation and tilt sensors 772, and a self-calibration system 795. Signals from electrical and magnetic sensors 730, 752 are magnified and also sent to processor 755. Processor 755 can then determine various characteristics of a lightning strike as set forth in more detail below.

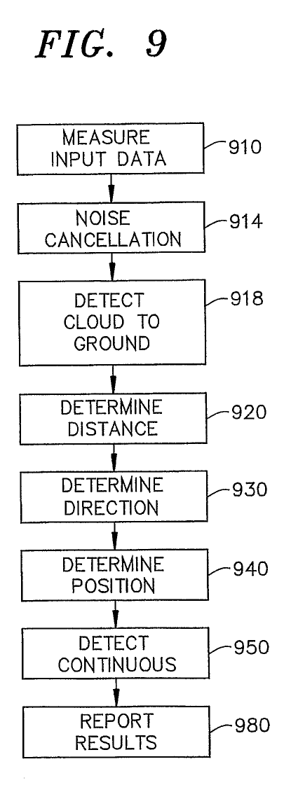

The preferred operation to make the determinations listed above will be detailed further below. FIG. 9 presents a flow chart depicting the general sensing process of the invention. Although reference will be made to the use of the process with the embodiment or FIG. 5, it should be understood that the same process could be used with the embodiment of FIGS. 7 and 8, as well as the earlier discussed embodiments. Initially it should be noted that controller 675 will not always perform all the listed steps nor will they necessarily be performed in a specific order. In any case, controller 675 can measure input of data in step 910, cancel external noise at 914, detect cloud to ground lightning at 918, determine the distance to the lightning event at step 920, determine the direction to the lightning event at 930, determine the position of the lightning event at 940, detect whether or not the lightning is continuous in step 950 and report results in step 980.

To determine the distance to a lightning event at step 920, one or both of the B-field sensors 652 are used to detect a primary signal that travels directly to sensors 652 from the lightning event, as well as a reflected signal which reaches sensors 652 after being reflected from the ionosphere. Additional signals corresponding to multiple reflections between the ionosphere and the ground are also often detected. Using the time difference between the arrival of the primary signal and the first reflected signal, combined with an estimate of the ionospheric height, h, simple geometry is employed to give a range estimate. If multiple reflection pulses are observed, the accuracy of the range estimate is improved.

One method to improve the accuracy of the pulse time determination is to measure the time differences on two or three of the sensing axes and, if the data is of high quality, take the average. Data interpolation are also employed. For example, by applying a 10× band limited interpolation to the original sampled signals, the effective time resolution is increased by a factor of 10.

Direction finding using the ratio of the peak magnetic field produced during the discharge in North-South (NS) and East-West (EW) directions is a well-established technique. However, traditional direction finding uses B-field data alone and there is 180-degree ambiguity in the arrival direction. Using an integrated E-field sensor with enough sensitivity, this ambiguity can be resolved with simultaneous vertical electric field data, because the Poynting vector (\vec{E}×\vec{B}) direction unambiguously defines the direction for the electromagnetic wave (\vec{ν}) generated by a lighting stroke. In this manner the direction to the lightning event is then determined in step 930. Integrated sensor system 600 preferably has the built-in orthogonality of two B-field sensors 652. This arrangement greatly enhances determining the direction of a lightning discharge as the measurements from two individual B-field sensors 652 which are aligned to be orthogonal in the field are compared and employed in the determination of direction.

Once the distance and direction of the lightning event are known, it is possible to determine the relative position in step 940 and/or to calculate the absolute position of the lightning event using the coordinates of sensor system 600 itself. The absolute position of sensor system 600 is determined from GPS 671. Once the direction and distance from the sensor system 600 to the lightning event is determined, the absolute position of the lightning event is determined by geometry. Thus, by using these two methods in conjunction with the compact sensing system 600 so described, it is possible to determine the position of a lightning event from a single local measurement without input from sensors in remote or even nearby locations.

In addition to detecting the pulses observed when a lightning event is produced, sensor system 600 will also detect and discriminate continuing current from return-stroke current at step 950. The continuing current is a current of perhaps ten to hundreds of amperes that occurs soon after a return lightning stroke. To be considered continuing current, it must have a lifetime of at least tens of milliseconds while the longest continuing currents may even last hundreds of milliseconds. Continuing current is an arc between the charge source in the cloud and the ground. It follows the path created by the return stroke that preceded it. Since continuing current persists for a relatively long time and hence can generate a lot of Joule heating, it is believed to be responsible for much of the lightning damage due to thermal effects, such as forest fire initiation and burned ground wires on overhead power lines. It is generally thought that continuing currents occur in roughly 25% of negative cloud-to-ground lighting flashes and about 80-90% of positive cloud-to-ground lighting strokes.

DC or quasi-DC electric field sensors are the traditional sensor for detecting continuing currents and have been used for decades. The slow transfer of charge in continuing currents produces a slow change in the quasi-static electric field in the vicinity of the discharge. The speed of this slow E change is in contrast to the fast E change (on the order of a millisecond) produced by lightning return strokes. Because quasi-static E changes are produced by above ground charge and the equivalent oppositely signed image charge below ground, they produce electric dipole-like fields that ultimately decay with distance away from the stroke as 1/r³. This limits the detection range of continuing currents with E sensors. The precise range limitation is a function of the sensor sensitivity, the background noise, and the continuing current amplitude and duration, and is on the order of 30-50 km for typical sensors and continuing currents.

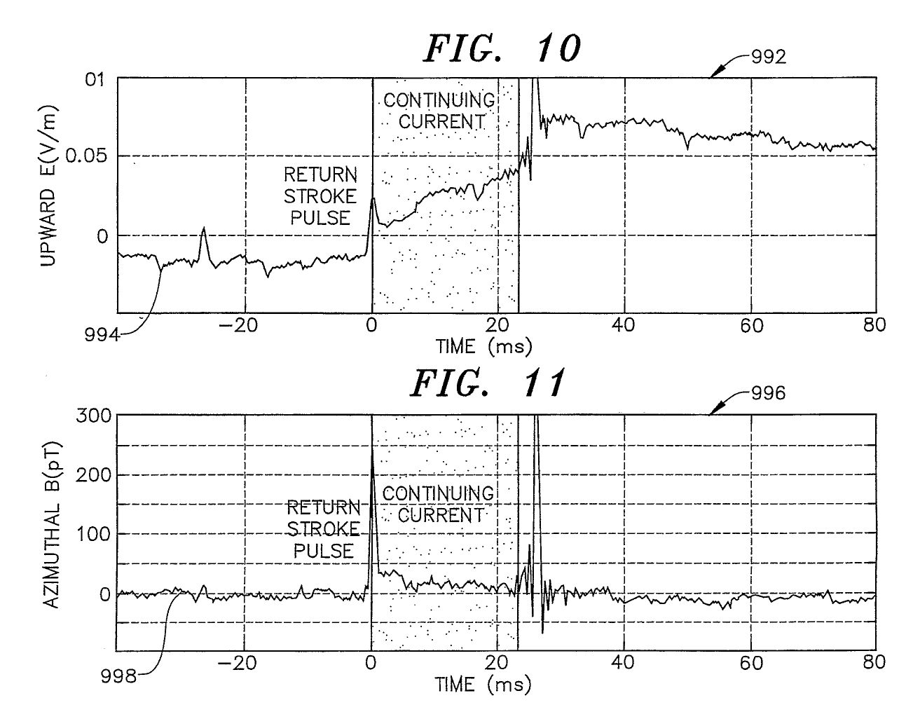

In contrast to the electric field, a steady (continuing) current creates a steady, quasi-static magnetic field. The lightning channel and its images in the ionosphere and ground constitute a long line current that generates a magnetic field that falls off as 1/r. This means that the detection range is potentially much longer than for an E sensor. A very large continuing current (as large as 5-10 kA) can be detected from a considerable distance such as 2500 km. Accordingly, a preferable aspect of the invention is that the B-field sensors have a frequency response that extends to the order of 1 Hz and adequate sensitivity at that frequency to detect continuing currents. An example of continuing lightning currents measured by such a system is shown FIGS. 10 and 11. FIG. 10 shows a graph 992 plotting an electric field value 994 while FIG. 11 shows a graph 996 plotting a magnetic field value 998.

In addition to the core sensing unit of one E-field and two B-field sensors, along with the associated orientation sensors, data acquisition and processing, several subsidiary aspects are addressed by the invention. In particular, the minimal quasi-static field for an E-field sensor to detect is usually limited by the background noise rather than by the sensor internal noise. However, the background noise is often highly coherent in both vertical and horizontal directions. Preferably, a horizontal E-field sensor 631 is employed on sensor system 600 to cancel the background noise at step 914, and thus improve the minimal vertical signal sensor system 600 can detect. FIG. 5 illustrates how horizontal sensor 631 can be integrated in addition to the vertical E sensor 630.

In addition, it is known that the electromagnetic pulses generated by cloud-ground (CG) and intracloud (IC) lightning strokes have different frequency spectra. In particular, CG lightning has a spectrum with a strong signal in the 2-6 kHz range, while IC lightning has a peak in the 100-400 kHz range. In one embodiment of this invention, magnetic induction sensor 652 has a sensitivity of 10-30 fT/Hz^{1/2} over the frequency range from 2 kHz to 400 kHz. This sensor bandwidth allows discrimination of CG and IC lightning in step 918.

Although described with reference to preferred embodiments of the invention, it should be readily understood that various changes and/or modifications can be made to the invention without departing from the spirit thereof. For instance, although the embodiments described above are directed to combination electric and magnetic field sensor systems, some benefits can be realized in connection with integrating a plurality of magnetic field sensors which can determine a vector field component of a magnetic field. In any case, the sensor system is compact in nature and highly sensitive, with the sensor system according to the preferred embodiments of the invention having a maximum dimension of less than 100 cm, the E-field sensors having sensitivities relative to their input in the range of about 1 mV/Hz^{1/2} at 1 Hz and the B-field sensors having sensitivities of at least 5 pT/Hz^{1/2} at 10 Hz and 0.4 pT/Hz^{1/2} at 100 Hz. In one particular embodiment, a higher B-field sensor sensitivity of 3 pT/Hz^{1/2} at 10 Hz and 0.3 pT/Hz^{1/2} at 100 Hz with a maximum dimension of less than 20 cm is achieved. In a still further embodiment, a very high B-field sensor sensitivity of 0.2 pT/Hz^{1/2} at 10 Hz and 0.03 pT/Hz^{1/2} at 100 Hz with a maximum lateral dimension of less than 50 cm is established. Each magnetic field sensor preferably also includes two or more magnetic induction sensors that contain high permeability cores, wherein the plurality of magnetic sensors are arranged to intersect at a lateral offset of less than 1 cm. In any case, the invention is only intended to be limited by the scope of the following claims.

I/We claim:

1. An integrated sensor system for monitoring and characterizing lightning events comprising:
an electric field sensor for receiving electric field data including electrical signals caused by a lightning event;
a first magnetic field sensor for receiving a first set of magnetic field data including a first magnetic field produced in a first direction;
a second magnetic field sensor for receiving a second set of magnetic field data including a second magnetic field produced in a second direction; and
a controller for calculating a distance and a direction to a lightning event relative to a position of the sensor system based on the electric field data and the first and second sets of magnetic field data.

2. The integrated sensor system of claim 1, further comprising:
means for measuring an amount of time between an arrival of a primary electromagnetic signal and a secondary electromagnetic signal.

3. The integrated sensor system of claim 2, wherein the primary magnetic signal travels directly from the lightning event to the first and second magnetic field sensors and the secondary magnetic signal travels from the lightning event and reflects off of the ionosphere before reaching the first and second magnetic field sensors.

4. The integrated sensor system of claim 1, wherein the controller includes a means for determining the direction to the lightning event by calculating a Poynting vector from measured electrical and magnetic components.

5. The integrated sensor system of claim 1, wherein the first and second magnetic field sensors are mounted orthogonal to one another.

6. The integrated sensor system of claim 1, further comprising:
a global positioning system for providing a signal representing a position of the sensor system.

7. The integrated sensor system of claim 6, wherein the controller includes means for calculating a location of the lightning event from the calculated direction and distance, as well as the position of the sensor system.

8. The integrated sensor system of claim 1, further comprising:
an orientation sensor for providing a signal representing an orientation of the sensor system.

9. The integrated sensor system of claim 1, wherein the controller includes means for identifying continuing current lightning.

10. The integrated sensor system of claim 9, wherein each of the first and second magnetic field sensors has a frequency response that extends to approximately 1 Hz.

11. The integrated sensor system of claim 1, further comprising: an additional electric field sensor for receiving further electric field data, wherein the controller uses the further electric field data to reduce noise measured by the electric field sensor.

12. The integrated sensor system of claim 1, wherein the controller includes means for distinguishing cloud-to-ground lightning from intracloud lightning by virtue of different frequency spectra as determined by the electric and magnetic sensors.

13. The integrated sensor system of claim 1, further comprising:
a housing compactly supporting the electric field sensor and the first and second magnetic field sensors.

14. The integrated sensor system of claim 13, wherein said housing is waterproof and contains a DC power source such that the sensor system is self-contained and portable.

15. A method for detecting a lightning event through a lightning sensor system comprising:
measuring magnetic field data associated with the lightning event along a plurality of distinct axes;
measuring electric field data associated with the lightning event along at least one of the plurality of distinct axes; and
calculating a distance and a direction of the lightning event relative to a position of the sensor system based on the electric field data and the magnetic field data.

16. The method of claim 15, further comprising:
determining the distance to the lightning event by travel-time measurements for both a primary electromagnetic signal, which travels directly from the lightning event to the sensor system, and a secondary electromagnetic signal which travels from the lighting event, reflects off the ionosphere and then travels to the sensor system.

17. The method of claim 16, further comprising:
using the primary electromagnetic signal and the secondary electromagnetic signal to estimate a height of the ionosphere.

18. The method of claim 15, further comprising:
determining the direction of the lightning event by calculating the Poynting vector from electric and magnetic field components.

19. The method of claim 15, further comprising:
determining positioning information for the sensor system through a global positioning system.

20. The method of claim 19, further comprising: determining the location of the lightning event from the positioning information of the sensor system and the direction and distance of the lightning event.

21. The method of claim 15, further comprising:
determining orientation and tilt of the sensor system.

22. The method of claim 15, further comprising:
detecting continuing current lightning.

23. The method of claim 15, further comprising:
measuring additional electric data caused by the lightning event oriented along another of the plurality of distinct axes; and
reducing background noise employing the additional electric data.

24. The method of claim 15, further comprising: distinguishing cloud-to-ground lightning from intracloud lightning through frequency spectra analysis.
